(19) United States
(12) Patent Application Publication
(10) Pub. No.: US 2017/0066108 A1
(43) Pub. Date: Mar. 9, 2017

(54) FORMING A SMOOTH MATTE SURFACE OF A CERAMIC MATERIAL

(71) Applicant: Apple Inc., Cupertino, CA (US)

(72) Inventors: Naoto Matsuyuki, Tokyo-to (JP); Douglas J. Weber, San Francisco, CA (US)

(21) Appl. No.: 14/965,180

(22) Filed: Dec. 10, 2015

Related U.S. Application Data
(60) Provisional application No. 62/213,794, filed on Sep. 3, 2015.

(51) Int. Cl. B24C 1/08; H04B 1/3888; B24C 11/00

(52) U.S. Cl. CPC B24C 1/08; B24C 11/00; H04B 1/3888

(57) ABSTRACT

Systems and methods for forming a smooth matte surface of a ceramic component using a double abrasive blasting process. A surface region of a surface of the ceramic component may be blasted in a first abrasive blasting process, using, for example, a first abrasive media comprised of a first abrasive material having a hardness that is greater than that of the ceramic component. The surface may be blasted another time in a second abrasive blasting process, using, for example, a second abrasive media comprised of a second abrasive material coupled to an elastic element. In the second abrasive blasting process, the second abrasive material may be harder than the ceramic component.

### CROSS-REFERENCE TO RELATED APPLICATION

This application is a non-provisional patent application of and claims the benefit to U.S. Provisional Patent Application No. 62/213,794, filed Sep. 3, 2015 and titled “Forming a Smooth Matte Surface of a Ceramic Material,” the disclosure of which is hereby incorporated herein by reference in its entirety.

### FIELD

The described embodiments relate generally to ceramic materials and, more particularly, relate to systems and methods for forming a smooth matte surface of a ceramic material using a two-stage abrasive blasting process.

### BACKGROUND

Zirconium dioxide (ZrO₂), is a white crystalline form of zirconium, and is generally referred to as zirconia. A partially stabilized zirconia microstructure, tetragonal zirconia polycrystal (TZP), is commercially available as a toughened zirconia ceramic. TZP is a pure tetragonal phase, very fine grain material typically stabilized with yttria. In general, TZP is a hard and strong material with a hardness of approximately 1300 kg/mm² on the Vickers scale, and, as such, is useful in wear resistant applications. Because of its hardness and toughness, TZP may be an attractive alternative to other tough materials like polycarbonate or sapphire. However, due to its inherent brittleness, TZP may be difficult to surface finish using traditional techniques.

### SUMMARY

In general, two-step abrasive blasting may be used to form a smooth matte surface of a ceramic component made from materials including zirconia or sapphire. A first abrasive blasting process of the surface may be performed using a first abrasive media. Following the first abrasive blasting process, the surface may be exposed to a second abrasive blasting process using a second abrasive media. The first and second abrasive media may have a hardness that is greater than that of the ceramic component. In the first and second blasting processes, blast systems are configured to propel the abrasive media against the surface of the component under high pressure. The first blasting process may create micro-cracks in the surface of the component, form a matte surface appearance, and increase the strength of the component through local volume expansion at the micro-cracks. The second blasting process may reduce a roughness and/or irregularities on the surface of the component to yield a smooth surface texture. A two-step blasting process may be particularly useful for finishing a surface of a ceramic component comprised of partially stabilized zirconia such as TZP, particularly if a smooth matte surface is desired.

Some example embodiments are directed to a method of forming a smooth surface of a ceramic component using a two-step blasting process. The surface of the ceramic component may be blasted in a first abrasive blasting process, using, for example, a first abrasive media having a hardness that is greater than that of the ceramic component. The surface may be blasted another time in a second abrasive blasting process, using, for example, a second abrasive media comprised of a second abrasive material coupled to an elastic element. In the second abrasive blasting process, the second abrasive material is likewise harder than the ceramic component.

In some embodiments, the first abrasive blasting process includes placing the first abrasive media and the ceramic component within a first blast system, and propelling the first abrasive media against the surface of the ceramic component by directing the propelled first media towards the surface using a pressurized stream of fluid.

In some embodiments, the second abrasive blasting process includes placing the second abrasive media within a second blast system, and, after performing the first abrasive blasting process, placing the ceramic component within the second blast system, and propelling the second abrasive media against the surface of the ceramic component by directing the propelled second media towards the surface using a pressurized stream of fluid.

In some embodiments, the ceramic component is comprised of a tetragonal crystal structure. The first abrasive blasting process may create irregularities in a surface region of the crystal structure. The crystal structure may undergo a phase change at the surface region proximal to the irregularities.

In some embodiments, the ceramic component is comprised of a tetragonal crystal structure with irregularities in a surface region of the structure. The second abrasive blasting process may flatten peaks of the irregularities to create a smooth surface texture of a matte surface.

In some implementations, the ceramic component is comprised of zirconia. The first abrasive media is comprised of sapphire, diamond, or of a material having a hardness that is greater than that of zirconia. The second abrasive material is comprised of sapphire, diamond, or of a material having a hardness that is greater than that of zirconia.

In some implementations, the ceramic component is comprised of sapphire. The first abrasive media and second abrasive material are comprised of diamond, or of a material having a hardness that is greater than that of sapphire.

In some cases, the surface of the ceramic component may be polished following the second abrasive blasting process to produce a polished surface of the matte surface. The polishing may round out the flattened peaks of the irregularities in the surface region.

Polishing the surface is performed using a mechanical polishing operation, a chemical mechanical polishing operation, or a combination of mechanical and chemical mechanical polishing operations.

Some example embodiments are directed to a method of finishing a surface of a ceramic component. The surface may be firstly finished in a first surface finishing process using a first polishing media to create micro-cracks in the surface. The micro-cracks define a superficial region of the surface having varying peaks and valleys along a length of the surface. The surface may be secondly finished in a second surface finishing process using a second polishing media to remove a corresponding tip of the peaks to produce a finished surface. In some embodiments, the first and second polishing media may comprise a natural or synthetic abrasive material having a hardness that is greater than that of the ceramic component. In some embodiments, the second polishing media may further comprise an elastomer coupled to the abrasive material. In some further embodiments, the second surface finishing process may be performed using a chemical etching material to produce a finished surface of the component.

Some example embodiments are directed to a method of finishing a zirconia component. An unfinished surface region of the zirconia component may be blasted using a first abrasive media to produce a matte surface region. The matte surface region may then be blasted using a second abrasive media to reduce a surface roughness of the matte surface region. In some embodiments, the zirconia component may comprise a tetragonal crystal structure and the matte surface region includes discontinuities in the tetragonal crystal structure. In some further embodiments, blasting the matte surface region repairs the discontinuities in the tetragonal crystal structure.

In some implementations, the surface forms a portion of a cover sheet to be disposed above a display of a portable electronic device. A user of the device is presented with a smooth tactile surface having a matte appearance.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A depicts a top view of an example electronic device;

FIG. 1B depicts a bottom view of the example electronic device of FIG. 1A;

FIG. 2 depicts an exploded view of the example electronic device;

FIG. 3 depicts another example electronic device;

FIG. 4 depicts an example ceramic component suitable for use with the example electronic device of FIGS. 1A-B;

FIG. 5A depicts a cross-sectional view of the ceramic component of FIG. 4;

FIG. 5B depicts a detailed cross-sectional view of a surface region of the ceramic component of FIG. 4 before the surface is subject to an abrasive blasting process;

FIG. 6A depicts a detailed cross-sectional view of the ceramic component after the surface of the component is subject to a first abrasive blasting process, the surface having varying microscopic peaks and valleys along its length;

FIGS. 6B-6C depict detailed cross-sectional views of the ceramic component during a second abrasive blasting process;

FIG. 6D depicts a detailed cross-sectional view of the ceramic component after the surface of the component is subject to a second abrasive blasting process;

FIG. 7 depicts a magnified view of a portion of FIG. 6A containing a micro-crack in the surface of the ceramic component; and

FIG. 8 depicts an example process for creating a smooth matte surface of a ceramic component.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to methods for forming a smooth matte surface of a ceramic component. The ceramic component may be formed from a transparent ceramic material, such as zirconia, sapphire, or other similar material. Numerous consumer and non-consumer devices utilize protective coverings, windows, and/or surfaces formed from hard materials, including various transparent ceramic materials. Compared to other optically clear materials, such as polycarbonate, hard ceramic materials like zirconia offer improved strength and fracture toughness. However, as previously mentioned, zirconia may be difficult to polish using traditional techniques. In particular, portions of a zirconia component having a matte surface may be difficult to polish to form a smooth matte surface using traditional techniques.

As described with respect to embodiments herein, two-step abrasive blasting may be used to form a smooth matte surface of a ceramic component made from materials including zirconia or sapphire. For purposes of the following discussion, the term smooth may refer to a surface that is free from perceptible projections or indentations. In one non-limiting example, a smooth surface may be a surface that has a uniform tactile finish as perceived by human touch.

The two-step abrasive blasting may include a first abrasive blasting process performed on the surface using a first abrasive media. Following the first abrasive blasting process, the surface may be exposed another time to a second abrasive blasting process using a second abrasive media. The first and second abrasive media may have a hardness that greater than that of the ceramic component. In the first and second blasting processes, blast systems are configured to propel the abrasive media against the surface of the component under high pressure. For ceramics that are formed from a crystalline structure, a first blasting process may create micro-cracks in the surface of the component which produce a matte surface appearance and increase the strength of the component through local volume expansion at the micro-cracks; and a second blasting process may flatten peaks of surface irregularities to reduce a roughness on the surface of the component and yield a smooth surface texture. Using conventional abrasive blasting systems, two-step blasting may be particularly useful for finishing a surface of a ceramic component comprised of partially stabilized zirconia such as TZP, particularly if a smooth matte surface is desired.

Some embodiments described herein are directed to methods of finishing a surface of a ceramic component. The surface may be processed using a first surface finishing process with a first polishing media to create micro-cracks in the surface. The micro-cracks may define a superficial region of the surface having varying peaks and valleys along a length of the surface. The surface may be further processed using a second surface finishing process with a second polishing media to remove a corresponding tip of the peaks to produce a finished surface. In some embodiments, the first and second polishing media may comprise a natural or synthetic abrasive material having a hardness that is greater than that of the ceramic component. In some embodiments, the second polishing media may further comprise a binder or matrix that at least partially encapsulates an abrasive material. The binder or matrix may include a soft compliant material, such as an elastomer or gel, which may include a gelatin or other form of collagen. The second surface finishing process may be performed using a chemical etching or an air blasting process to produce a finished surface of the component.

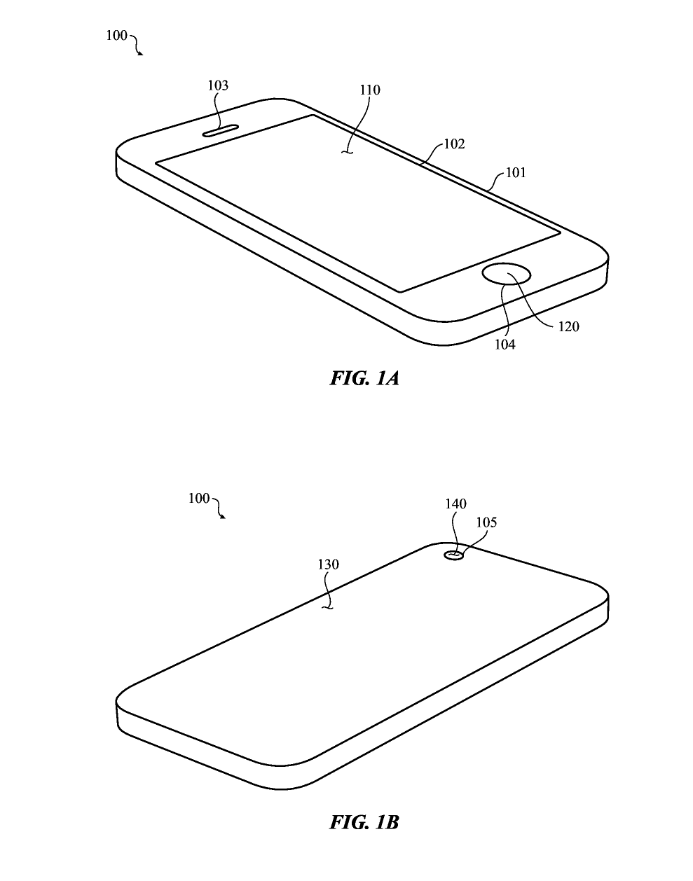

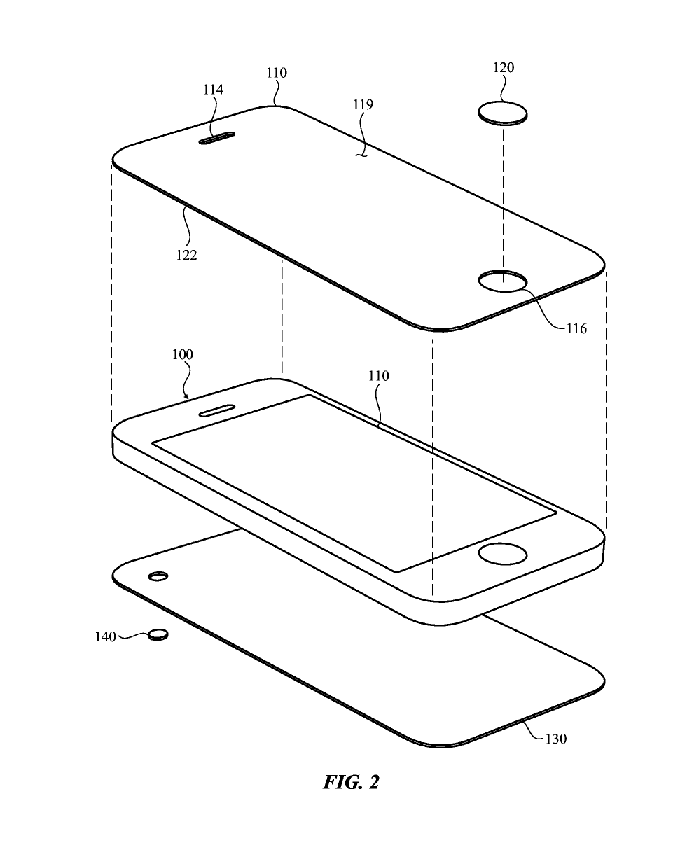

These and other embodiments are discussed below with reference to FIGS. 1A-8. However, those skilled in the art will readily appreciate that the detailed description given herein with respect to these Figures is for explanatory purposes only and should not be construed as limiting.

FIGS. 1A-1B depict an example electronic device having one or more ceramic components that are finished using two-step abrasive blasting technique briefly described above. A more detailed description of a two-step blasting process is also provided below with respect to FIG. 8. FIGS. 1A-1B depict a device having multiple protective sheets that are formed from a ceramic material, such as zirconia. While the following examples are provided with respect to protective sheets formed from a zirconia component, other ceramic materials may also be used, including, for example, various forms of glass, sapphire, and the like.

In the present example, the protective sheets are formed from one or more zirconia components, which may provide outstanding wear resistance and enhance the mechanical integrity of the device. A protective sheet may also function as an optically transmissive window and provide visibility to underlying components, such as displays or graphical elements. In many implementations, both the optical and mechanical properties of the protective sheets may be important to perception of quality and performance of the device. It may be desirable for the surfaces of the protective sheets to have a smooth surface that is free from perceptible projections or indentations. The protective sheets may have a smooth surface that has a uniform tactile feel as compared to surface that has a perceptible surface texture, surface roughness, or otherwise uneven tactile feel. The protective sheets may also have a surface that is smooth enough to prevent or reduce the accumulation of dirt, human skin, or other solid contaminants after repeated use or contact with human skin. The protective sheets may also have a matte, diffuse, or otherwise non-specular optical finish.

As shown in FIG. 1A, the device 100 includes a protective cover sheet 110 formed from a zirconia component and is used as an optically transmissive protective layer. The cover sheet 110 may be attached to an enclosure 101 of the device 100 using an optically transmissive adhesive or other bonding technique. In one example, the cover sheet 110 is attached to the enclosure 101 using a pressure sensitive adhesive (PSA) film. In some embodiments, a channel may be machined or otherwise formed around the perimeter of the cover sheet 110 in which an adhesive may be introduced and used to bond the cover sheet 110 to the enclosure 101. The cover sheet 110 may also be attached to or otherwise disposed above the display 102, which may protect the display 102 from scratches or other physical damage.

The cover sheet 110, depicted in FIG. 1A, is formed from a zirconia component having an overall thickness of less than 100 μm in one example. In some embodiments, the overall thickness of the cover sheet 110 is between approximately 0.05 mm and 1 mm. Moreover, the cover sheet 110 may be formed into a variety of non-sheet shapes, including components that have multiple features of different thicknesses.

The cover 110 may be formed from a single sheet of zirconia material or, alternatively, be formed from a laminate material made from multiple layers and having at least one layer formed from a sheet of zirconia. In the present example, the side of the cover sheet 110 that is external to the device may be finished to a smooth matte surface finish and may also include an anti-reflective or other type of coating to enhance the optical properties of the cover sheet 110.

Opposite to the exterior side of the cover sheet 110, an ink or paint may be applied to a perimeter portion to form a solid, opaque border that surrounds a center viewable portion of the cover sheet 110. The center portion of the cover sheet 110 remains optically transmissive and may be polished to a finished surface. In some implementations, the perimeter portion that is painted has a surface finish that is less polished than other portions of the cover sheet 110 in order to facilitate paint adhesion and/or bonding properties with other components of the device 100.

The enclosure 101 may define an opening in which the display 102 is positioned or disposed. The display 102 may include a liquid crystal display (LCD), organic LED display, or similar display element. Because the cover sheet 110 overlays the display 102, optical quality and physical strength are important aspects of the cover sheet's functionality. The cover sheet 110 may also be attached to, or be integrated with, a transparent electronic sensor that overlays the display 102. In some cases, the electronic sensor covers the entire display 102 and is used as the main input device for the user. In some implementations, the cover sheet 110 may be integrated with capacitive touch and force sensors used to detect finger or stylus touches on the surface of the cover sheet 110.

As shown in FIG. 1A, the front surface of the device 100 also includes a button sheet 120 used to protect the surface of the control button 104. In this example, the button sheet 120 is formed from a zirconia sheet and is used as an optically transmissive protective layer. The button sheet 120 protects the surface of the control button 104 and may have a smooth matte surface finish. However, it is not necessary that the button sheet 120 be optically transmissive or finished to a smooth matte surface finish. For example, the button sheet 120 may be opaque and an outer surface of the button sheet 120 may have a surface finish configured to provide an appropriate aesthetic appearance or tactile quality. For instance, it may have a high degree of polish to facilitate visibility of a graphical element or symbol printed on the control button 104 and/or to visibly distinguish the button sheet 120 from the cover sheet 110. The button sheet 120 may be formed as a flat sheet or may be formed as or include a contoured or curved surface.

The button sheet 120 may enhance the mechanical integrity of the control button 104, which is used as an input to the device 100. In the present example, the control button 104 includes a tactile switch which is operated by depressing the control button 104. The control button 104 may also include or be associated with an electronic touch sensor, such as a capacitive touch and/or force sensor, or biometric sensor. The button sheet 120 may be attached directly to an actuator or housing of the control button 104 and may, alternatively, be attached to or integrated with the electronic touch sensor of the control button 104.

In certain embodiments, the button sheet 120 depicted in FIG. 1A is formed from a zirconia sheet having an overall thickness of approximately than 100 μm and, in some embodiments, between approximately 1 mm and 0.05 mm. Other thicknesses and dimensions are also envisioned. Similar to the cover sheet 110, the button sheet 120 may be formed from a single sheet of zirconia material or, alternatively, be formed from a laminate material having at least one layer formed from a sheet of zirconia. In some cases, the button sheet 120 is formed from the same material as the cover sheet 110, although this is not necessary. One or both sides of the button sheet 120 may also be printed or coated to enhance the optical properties of the zirconia component.

FIG. 1B depicts a back view of the device 100 having one or more protective covers formed from zirconia components. In this example, the back surface of the device 100 is covered by a back sheet 130. Similar to the cover sheet 110, the back sheet 130 may be formed from a zirconia component and is used as an optically transmissive protective layer. Also, similar to the cover sheet 110, the back sheet 130 may be formed from a single sheet of zirconia material or, alternatively, be formed from a laminate material having at least one layer formed from a sheet of zirconia. In some cases, the back sheet 130 is formed from the same material as the cover sheet 110, although this is not necessary. In this case, the back sheet 130 covers the entire back of the device 100, except for the area near the camera lens 105. A separate camera cover 140 may be used to protect the camera lens 105. The camera cover 140 may be formed as a flat sheet or as a contoured shape. The camera cover 140 may also be configured to function as an optical lens or other optical element. In an alternative embodiment, the back sheet 130 also covers the camera lens 105 and the separate camera cover 140 is not used.

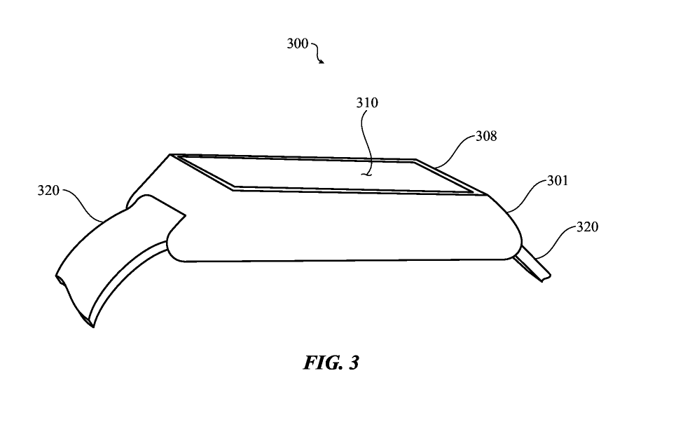

FIG. 2 depicts an exploded view of the example device 100 with the covers separated from the device. As shown in FIG. 2, the front of the device 100 is substantially covered by the cover sheet 110 and the button sheet 120. The back of the device 100 is substantially covered by the back sheet 130 and the camera cover 140. While this is provided by way of example, fewer or more cover sheets may be used to protect various aspects of the device 100.

In the depicted example, the cover sheet 110 includes a substantially planar or flat front surface 119. As described in more detail below with respect to FIG. 8, the front surface 119 may be finished using a two-step abrasive blasting operation or process. In some embodiments, the planar front surface 119 may be polished using an abrasive-based or laser-based polishing process.

Opposite to the front surface 119, the cover sheet 110 includes a substantially planar or flat bottom surface 122. The bottom surface 122 may be polished, for example, using a laser-based polishing process or a traditional abrasive-based polishing technique. The bottom surface 122 of the cover sheet 110 may, in some cases, be finished using a two-step abrasive blasting operation to match or substantially match the smooth matte surface finish on the front surface 119. In some implementations, the bottom surface may be polished to produce a surface finish that is more or less polished than other portions of the cover sheet 110, such as the front surface 119. The reduced level of polish may be acceptable in a location that is outside of the viewable area of the display 102 (FIG. 1A).

As shown in FIG. 2, the cover sheet 110 may include a combination of planar and non-planar features or contoured that may be finished in accordance with the present disclosure. It may be generally beneficial that all of the features of the cover sheet 110 have a surface finish having a particular quality and consistency. Uniform surface finish or polish may enhance the quality and performance of the device. For example, uniform surface finish and/or polish over the cover sheet 110 may enhance the aesthetic qualities of the device 100 and also improve the strength by removing or reducing structural defects in the material.

In particular, the cover sheet 110 includes two openings which extend through the thickness of the cover sheet 110: a button opening 116 and a speaker opening 114. The button opening 116 is formed as a generally circular shape and is sized to receive the button and/or the button sheet 120. The speaker opening 114 is formed as an elongated or non-circular shape and is sized to allow sound to pass from an internal speaker 103 to the user's ear. While the button opening 116 and speaker opening 114 are shown as closed features, either or both of the openings may be formed as an open-sided shape, such as a u-shape, elongated notch, or the like.

For the example depicted in FIG. 2, the various features may be finished using different processes to substantially match each other. In particular, the various features and surfaces (e.g. bottom surface 122, speaker opening 114, button opening 116, button sheet 120, back sheet 130) may be finished using an abrasive blasting process and/or laser based polishing technique that is configured to match the degree of surface finish and/or polish of a two-step abrasive blasting operation used to finish the front surface 119. In some embodiments, the various features of FIG. 2 may each include a different degree of surface finish and/or polish. The degree of surface finish and/or polish may correspond to the roughness of the surface, rather than the use of any particular polishing or machining process.

The features identified above are merely exemplary, and different parts may have different features. In some embodiments, features are consistent with boundaries between different surface finishes and/or polishes. In other words, any contiguous area of a certain surface finish may be considered a feature. Thus, a single plane may include multiple features if the plane has distinct areas of different surface finishes and/or degrees of polish.

FIG. 3 depicts another example device 300 that includes a zirconia component. In particular, the device 300 is a wearable consumer product that includes a cover 310 formed from a zirconia component. In some embodiments, the device 300 is a wearable device, wearable electronic device, health monitoring device, and/or other wearable consumer product. The device 300 may also include non-electronic devices, such as a mechanical watch or other wearable product that include a cover or component formed from a zirconia component.

Similar to the example covers described above with respect to FIGS. 1A-B, and 2, the cover 310 of FIG. 3 may be formed from a zirconia material. Also similar to the previously described examples, the cover 310 may provide both structural or mechanical protection for the device 300, as well as high optical quality for viewing the display 308 or other visual element of the device 300. As described in more detail below, the cover 310 may be finished using a two-step abrasive blasting process to form a smooth matte surface finish.

As shown in FIG. 3, the device 300 includes a body 301 having an opening. The display 308 is positioned or disposed within the opening, and the cover 310 is positioned or disposed over the display 308. Similar to the previous example, the display 308 may include a liquid crystal display (LCD), organic light emitting diode (OLED) display, electroluminescent (EL) display, or other type of display element. Because the cover 310 overlays or is disposed over the display 308, the optical quality, surface finish, material thickness, and/or physical strength of the component may be relevant aspects of the cover 310, alone or in conjunction with other such aspects. The cover 310 may also be attached to, or be integrated with, a transparent electronic sensor that overlays the display 308. In some cases, the electronic sensor covers the entire display 308 and serves as the main input for the device 300.

As shown in FIG. 3, the device 300 may also include an attachment component 320. The attachment component 320 may include a band or strap formed from a variety of materials, including cloth, synthetic fiber, polymer, metal, leather, and so on. The attachment component 320 may be configured to attach the device 300 to a body part of a user, such as the user's wrist or portion of the user's arm. In some embodiments, the attachment component 320 may also include a zirconia component used to protect one or more exterior surfaces.

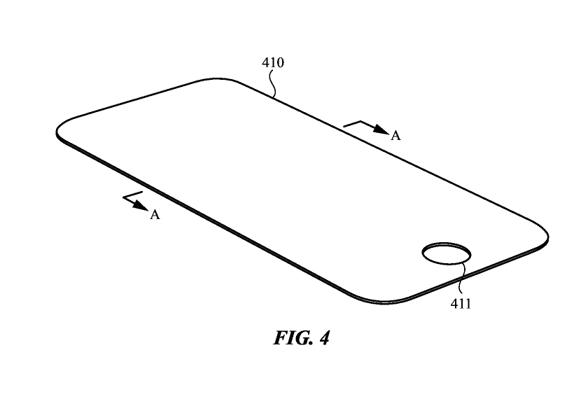

FIG. 4 depicts an example zirconia component 410 which may be finished using the two-step abrasive blasting processes described herein. To simplify the following description, repeated reference is made to the example zirconia component 410 depicted in FIG. 4, which may correspond in geometry and other aspects to the front cover sheet 110 described above with respect to FIG. 1A. While the zirconia component 410 is provided as one example, the systems and techniques described below may also be used to treat or otherwise process other example covers described above (e.g., 110, 120, 130, 310) as well as other zirconia-based components.

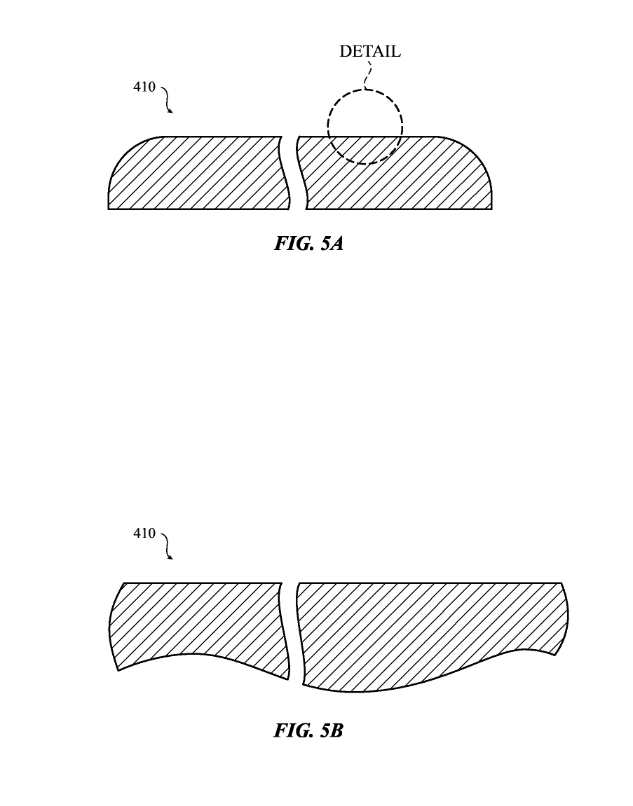

FIG. 5A depicts a cross-sectional view of the zirconia component 410 taken along Section A-A of FIG. 4. As shown in further detail, FIG. 5B depicts a detailed view of a surface region of the ceramic component of FIG. 5A. As depicted, the surface of the ceramic component is generally planar in an unfinished state. That is, FIGS. 5A and 5B depict the surface of the ceramic component prior to being subjected to a first and/or second blasting process as described in detail below with respect to FIG. 8. In the depicted example, an exterior surface of the component appears substantially smooth and flat. Although, it is to be appreciated that the surface may contain certain surface irregularities, discontinuities, micro-cracks, or other surface defects, and may have a degree of roughness that is not depicted in the figure. Further, the surface may have already been polished and/or finished in prior polishing or finishing processes not described herein.

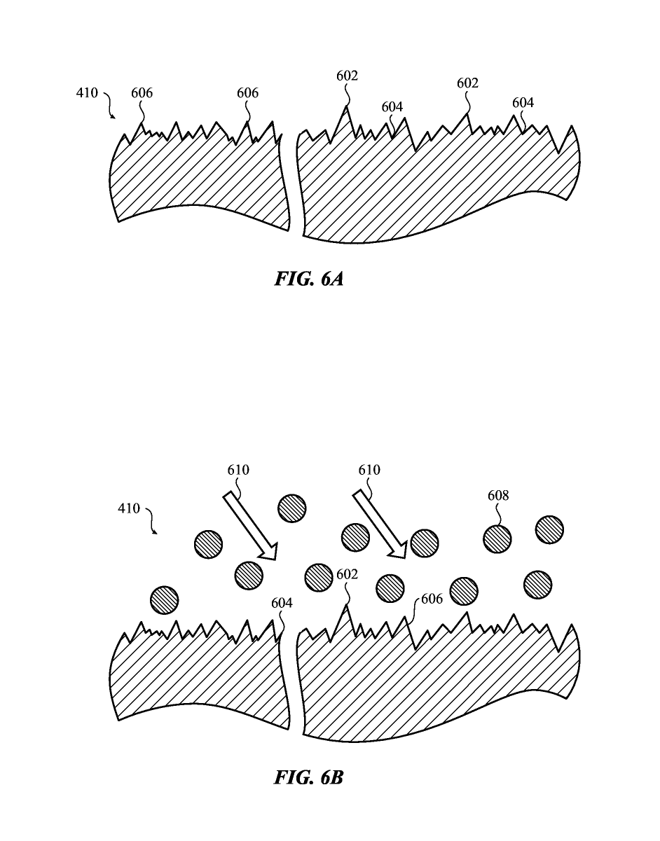

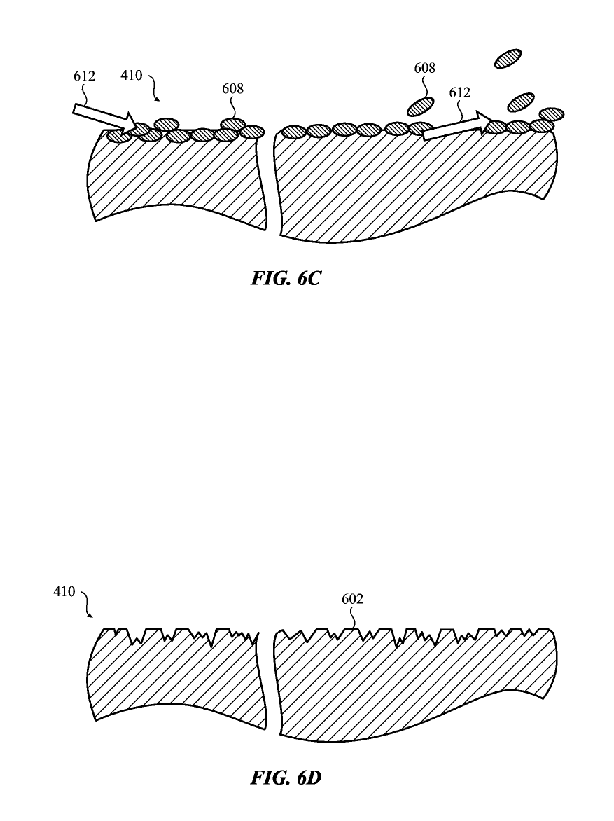

FIG. 6A depicts a detailed cross-sectional view of the ceramic component after the surface of the component is subject to a first abrasive blasting process. In the depicted example, an exterior surface of the component 410 contains varying repeating microscopic peaks 602 and valleys 604 along its length. The peaks 602 contain sharp tip features 606 which may increase the surface roughness of a surface region of the component. In a two-step abrasive blasting process described in further detail below with respect to FIG. 8, a first abrasive blasting of the surface may create the sharp micro-topography depicted by creating surface defects or micro-cracks in the surface region that is exposed to the abrasive blasting process. The surface depicted in FIG. 6A may be formed using an abrasive medium that is propelled against the surface of the part 410 to form a surface having sharp peaks 606 and/or tips 606.

While the surface treatment may produce a desired matt optical finish, the surface roughness of the part may be too great for a desired tactile feel. Additionally, the sharp peaks 606 and valleys 604 may tend to scrape and collect dirt, skin, or other solid contaminates from objects that contact the component 410. Thus, it may be desirable to expose such a surface region having an increased roughness due to sharp micro-topography to a further finishing process in order to reduce the surface roughness.

FIGS. 6B-6C depict various cross-sectional views of the component during a second abrasive blasting process wherein the surface of the component is subject to an abrasive medium. In general, an abrasive medium 608 is propelled under high pressure in a direction 610 towards the surface region of the component having peaks 602 and valleys 604 along its length. The abrasive medium 608 may be propelled using a gas stream or other directed fluid stream. The abrasive medium may be forced across the surface region following a direction 612 using known blasting techniques for propelling media. The movement of the abrasive medium across the surface along the direction 612 may remove the sharp tips 606 of the peaks 512 causing the peaks 512 to appear truncated or flattened, as shown in FIG. 6D. This may result in a surface having a reduced roughness as compared to the surface following the first abrasive blasting operation (FIG. 6A).

As an alternative to an air blasting process, the abrasive medium 608 may be included in a chemical slurry and passed across the surface of the part. The chemical slurry may include a high pH component that is adapted to etch or soften the material forming the sharp tips 606. In some cases, the abrasive medium 608 may be forced across the surface using a pad or other similar type of component.

The abrasive components used in the first and/or second surface treatment processes may include a material that is harder than the material that forms the part. In some cases, the abrasive components include a sapphire constituent, a diamond constituent, or other similar type of hard abrasive particulate. In some cases, the abrasive component is embedded or partially encapsulated within a binder or matrix material. For example, an elastomer or gel may be used to form small clusters of abrasive particulates that are used to treat the surface of the component 40. The binder or matrix may include an elastomer, such as a polymer or similar material. The binder or matrix may also include a gel, such as a collagen or other similar material.

In some implementations, the surface finish produced by the first and second abrasive blasting processes may be described as being a smooth finish. In particular, the treated surface of the zirconia component 410 may have a tactile feel that is uniform and free of perceptible projections and/or indentations. While the example surface finish depicted in FIG. 6D includes some irregularities along the surface, which are exaggerated for purposes of illustration, the surface may feel and appear smooth as perceived by a human touch. The surface finish may also have a matte, diffuse, or otherwise non-specular optical finish.

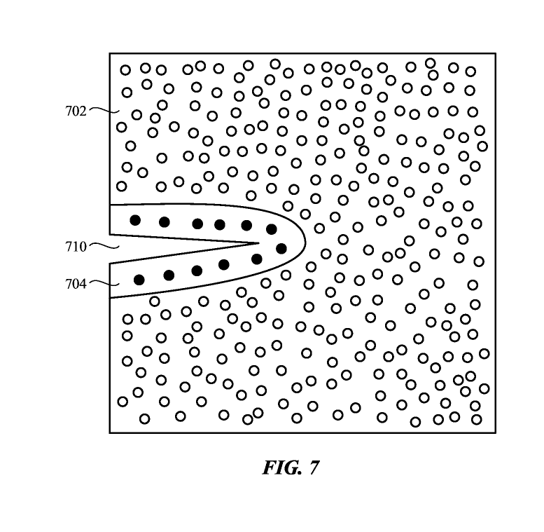

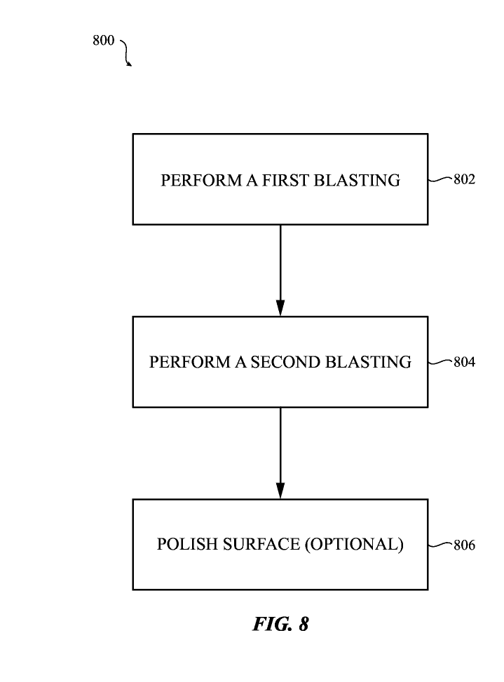

FIG. 7 depicts a magnified view of a portion of a surface region of a zirconia component containing a micro-crack 710 in the surface as an example surface irregularity. The micro-crack may, in some cases, be formed as a result of an abrasive blasting process. The propagation of such a micro-crack 710 may be retarded or reduced, as described herein. For example, using an abrasive blasting operation in accordance with some embodiments may result in phase change for material near the surface of the micro-crack 710. In some cases, an abrasive surface treatment may be used to induce the crystal structure at the surface to undergo a phase transformation from the metastable tetragonal phase to the monoclinic phase. As shown in the example of FIG. 7, the stress concentration at the crack tip may experience a local phase change from a tetragonal grain structure 702 to a monoclinic grain structure 704. This transformation may result in a local volume expansion at the crack tip due to the monoclinic structure having a larger specific volume. This phase transformation may then produce a residual compressive stress which retards the growth of the crack and increases the fracture toughness of the surface region. In particular, this transformation toughening effect may result in the surface region of a zirconia component having a flexural strength of approximately 1000 MPa, a high compressive strength of approximately 2000 MPa, a high fracture toughness of approximately 9.5 MPa·m^{-1/2}, and a high hardness of approximately 1350 HV₃₀. As a result of this transformation toughening, a zirconia component having a very high strength and wear resistance may be desirable for use in many different manufacturing and product applications.

FIG. 8 depicts an exemplary process 800 that may be used to finish a surface region of a zirconia component 410. The finishing process 800 may be used to improve the surface finish and/or reduce surface roughness of surfaces on a ceramic component. In particular, the finishing process 800 may be used to produce a smooth matte surface finish of a surface on a ceramic component. In addition, the finishing process 800 may also strengthen and/or repair finished regions by removing or healing defects formed in the surface of the component.

In general, a two-step abrasive blasting process may be used to obtain a smooth matte surface finish over a localized surface region of a ceramic component. In particular, a two-step abrasive blasting process as described in more detail below with respect to the example processes of FIG. 8, below, may be well suited for finishing a surface of a ceramic component comprised of partially stabilized zirconia such as TZP, particularly if a smooth matte surface is desired. For ceramics that are formed from a crystalline structure, a first blasting process may create micro-cracks in the surface of the component which simultaneously yield a matte surface appearance and increase the strength of the component through local volume expansion at the micro-cracks; and a second blasting process may flatten peaks of surface irregularities to reduce a roughness on the surface of the component and yield a smooth surface texture.

In general, the zirconia component that is processed according to this process 800 may be used as a protective cover sheet on a device in accordance with the examples provided above with respect to FIGS. 1A-3. The processes can also be used to produce a zirconia part used in a variety of other applications, including structural laminates, optical plates, and the like.

For purposes of the following description, a zirconia component is described generally as an example ceramic component. However, process 800 may also be applied to other types of ceramics having various form factors. In the following examples, the zirconia component may include a sheet of zirconia material less than 3 mm thick and may be obtained from a variety of sources, natural and/or synthetic. In some cases, the zirconia component may be a laminate composite having multiple layers and at least one layer made from a zirconia material. Other layers in the zirconia laminate may include, for example, silicate glass, a polymer sheet, or additional layers of zirconia material.

FIG. 8 depicts a flow chart of operations for the example process 800 for finishing a zirconia component. The process 800 may be used to finish a surface region of a part such as the cover sheets 110, 120, 130, and 310 described above, with respect to FIGS. 1A-3.

In operation 802, a surface region of the component is subject to a first abrasive blasting process. In some implementations, the first abrasive blasting operation uses a fine abrasive agent or media which is propelled against the surface region of the component under high pressure. For example, the surface of the zirconia component may be firstly blasted with an alumina-based abrasive medium. In some cases, the first abrasive agent may be at least substantially comprised of a material having a hardness that is greater than that of the component, such as sapphire, diamond, or the like. In some cases the abrasive medium includes an alumina-based medium having a hardness of approximately 9 on the Mohs scale and have a grain size between 0.053 and 1.70 mm.

In some embodiments, the first abrasive blasting process results in a surface having a surface finish that is substantially matte in appearance. Matte may appear as a haze on the surface of the component. In general, surface defects may have an impact on the visual appearance of the zirconia component post-blasting. For example, the matte appearance may be the result of light interference occurring with light refracted through repeating varying micro-peaks and valleys on the surface of the zirconia component. In some cases, the peaks and valleys structure results from the creation of surface defects or micro-cracks in the surface of the zirconia component following the abrasive blasting operation.

As described above with respect to FIG. 7, superficial micro-cracks in the zirconia component may induce a local phase change in the crystal structure which enables strengthening of the surface region by a local volume expansion at the crack tips. In particular, in a static force strength test applying 20 kg·m/s² pressure to the surface, the first abrasive blasting process may result in a surface of the component having an increase in strength of approximately 230 MPa compared to the surface strength prior to the first blasting process. In addition, in an impact strength test performing a 130 g ball drop onto the unsupported surface, the first blasting process may result in an increase in the failure height of approximately 10 cm compared to the failure height of the surface prior to the first blasting process. Thus, as well as being aesthetically desirable to produce a zirconia component having a matte surface appearance, it may be an important factor in producing parts having high strength and wear resistance.

In operation 804, the surface region of the component is subject to a second abrasive blasting process. In particular, one or more finished matte surfaces of the zirconia component may be further finished using the second abrasive blasting process. In some cases, the second abrasive blasting operation uses a fine abrasive agent or media which is propelled against the surface region of the component under high pressure. For example, the matte surface of the zirconia component may be secondly blasted with a diamond-based abrasive medium. In some cases, the second abrasive agent may be at least substantially comprised of a material having a hardness that is greater than that of the component, such as sapphire, diamond, or the like. In particular, the diamond-based medium may have a hardness of approximately 10 on the Mohs scale and have a grain size between 0.5 and 230 μm.

With regard to operation 804, the second abrasive blasting process may use a second abrasive media comprised of an abrasive agent coupled to a binder or matrix material, which may include an elastic element such as a polymer, elastomer, gel, or collagen. For example, the second abrasive media may include a diamond-based abrasive agent coupled to an elastic element formed from softer binding material. The elastic element may be formed from one or more of, a gel, collagen, polymer, elastomer, resin, or other similar material. The elastic element may include a variety of other types of materials having an elasticity that is greater than the abrasive agent. In one embodiment, the abrasive agent having an abrasive capability may be embedded and/or dispersed within an elastic element. In another embodiment, the abrasive agent may be carried on a surface of the elastic element.

In general, the elastic element may be used to soften the abrasive agent on the surface of the component. In particular, as the abrasive agent collides with the surface to be processed, the elastic force of the elastic element may prevent or reduce the formation of depressions or other surface defects that may correspond to the shape of the abrasive agent on the surface being processed and also may prevent the abrasive agent from being embedded on the surface. In this case, the elastic element may absorb the impact upon collision with the surface in order to prevent the abrasive agent from being embedded.

The second abrasive blasting process may provide a more refined finishing after the initial blasting operation of 802. For example, the second abrasive blasting process may be configured to flatten the tips of the peaks to thereby reduce the overall surface roughness of the surface region. In particular, the surface following the second blasting process may have a roughness that is approximately 260 nm, as compared to the surface following the first blasting process having a roughness of approximately 325 nm. In general, a smooth matte surface finish of the zirconia component is produced by flattening the sharp micro-peaks using a diamond-based abrasive agent coupled to an elastic element, such as a rubber or elastomer element.

In some cases, the surface following the second blasting process may have an increased impact strength or resistance as compared to the surface following the first blasting process. In particular, the failure height of the surface following the second blasting process may increase by approximately 15 cm compared to the failure height of the surface following the first blasting process. In general, a zirconia component having an increased impact strength is produced by a second abrasive blasting process which eliminates texture tips of the surface, thereby removing stress concentration points on the surface. The resulting surface having minimized or reduced stress concentration points is stronger and, in impact ball drop strength tests, has a failure height that is at least 13 cm higher than the failure height of the surface following the first abrasive blasting process.

With respect to the example provided above with respect to FIG. 2, one or both of the top surface 119 and the bottom surface 122 may be finished using an abrasive blasting technique. In some implementations, operations 802, 804 may include a mechanical polishing operation, a chemical mechanical polishing operation, or a combination of mechanical and chemical mechanical polishing operations. Example abrasive blasting techniques may include use of a slurry liquid media having the abrasive media suspended within the slurry. For chemical mechanical polishing operations, the slurry may also include an etchant or other chemical compound, which may be used to soften or etch the material on the surface of the component. The abrasive slurry may be forced across the planar surface using a polishing pad or other polishing tool. The abrasive slurry may also be forced across the planar surface using a pressurized stream or other similar technique for moving fluid.

In a non-limiting operation 806, a polishing process is performed. In an optional further embodiment of operation 806, the smooth matte surface of the zirconia component is polished using a laser-based polishing or abrasive-based polishing system to remove surface discontinuities or other surface roughening features. In particular, the surface region of the surface of the component may be polished to round out the flattened tips of the micro-peaks to form a polished surface. The polished surface may have a decreased roughness as compared to the surface before polishing. For example, the surface following the optional polishing process may have a roughness of approximately 0 to 5 nm.

The polishing process may provide an even more refined finishing after the previous finishing operations of 802 and 804. In another embodiment of operation 806, the polishing process may form a gloss surface on the polished surface. Operation 806 may be performed as the next finishing operation after operation 804. Operation 806 may also be performed after multiple, intermediate finishing operations that follow operation 804. In some embodiments, operation 806 is the final finishing operation after a series of two or more previous finishing operations.

While process 800 is described above with respect to three discrete finishing operations, variations of the above-described process may also be performed. For example, in some cases, only two of the finishing operations (e.g., operations 802 and 804) may be performed without performing a third finishing operation. Additionally, in some cases more than three finishing operations may be performed.

While any methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations are not a limitation of the present disclosure.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. These and other variations, modifications, additions, and improvements may fall within the scope of the disclosure as defined in the claims that follow.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A method of forming a smooth surface of a zirconia component, the method comprising:
performing a first abrasive blasting process on a surface of the zirconia component using a first abrasive media, the first abrasive media having a hardness that is greater than that of the zirconia component; and
performing a second abrasive blasting process on the surface of the zirconia component using a second abrasive media to reduce a surface roughness of the surface, the second abrasive media comprising:
an elastic element; and
a second abrasive material coupled to the elastic element, the second abrasive material having a hardness that is greater than that of the zirconia component.

2. The method of claim 1, wherein:
the zirconia component comprises a tetragonal crystal structure;
the first abrasive blasting process creates irregularities in a surface region of the crystal structure; and
the crystal structure undergoes a phase change at a surface region proximal to the irregularities.

3. The method of claim 1, wherein performing the first abrasive blasting process comprises propelling the first abrasive media against the surface of the zirconia component using a pressurized stream of fluid.

4. The method of claim 1, wherein performing the second abrasive blasting process comprises:
after performing the first abrasive blasting process, propelling the second abrasive media against the surface of the zirconia component using a pressurized stream of fluid.

5. The method of claim 4, wherein:
the zirconia component comprises a tetragonal crystal structure with irregularities in a surface region of the crystal structure; and
the second abrasive blasting process flattens the irregularities to reduce a surface roughness of the surface.

6. The method of claim 1, wherein:
the first abrasive media comprises a sapphire constituent; and
the second abrasive material comprises a diamond constituent.

7. The method of claim 1, wherein:
the first abrasive media comprises a diamond constituent; and
the second abrasive material comprises a sapphire constituent.

8. The method of claim 1, wherein the first abrasive media and second abrasive material both comprise a sapphire constituent or diamond constituent.

9. The method of claim 1, further comprising:
polishing the surface of the zirconia component to produce a polished surface.

10. The method of claim 9, wherein polishing the surface occurs after performing the second abrasive blasting process.

11. A method of finishing a surface of a ceramic component, comprising:
performing a first surface-finishing process on a surface of the ceramic component using a first polishing media to form micro-cracks in the surface, the micro-cracks defining a region of the surface having varying peaks and valleys; and
performing a second surface-finishing process on the surface of the ceramic component using a second polishing media to remove corresponding tips of the peaks to produce a finished surface of the component.

12. The method of claim 11, wherein the first and second polishing media comprise an abrasive material having a hardness that is greater than that of the ceramic component.

13. The method of claim 12, wherein the second polishing media further comprises an elastomer coupled to the abrasive material.

14. The method of claim 11, wherein the second surface-finishing process is performed using a chemical etching material to produce a finished surface of the component.

15. A method of strengthening a zirconia component, comprising:
blasting a surface region of the zirconia component using a first abrasive media thereby increasing a surface strength of the zirconia component; and
blasting the surface region using a second abrasive media thereby further increasing the surface strength of the zirconia component.

16. The method of claim 15, wherein blasting the surface region of the zirconia component using the first abrasive media increases the surface strength of the zirconia component by at least 230 MPa.

17. The method of claim 16, wherein blasting the surface region of the zirconia component using the second abrasive media increases an impact resistance of the zirconia component.

18. The method of claim 16, wherein blasting the surface region using the second abrasive media reduces a surface roughness of the surface region.

19. A portable electronic device comprising:
an enclosure;
a display disposed in an opening of the enclosure; and
a cover attached to the enclosure and positioned over the display, the cover including a zirconia component having micro-cracks and flattened peaks formed over a surface region.

20. The portable electronic device of claim 19, wherein the surface region forms a portion of a cover sheet to be disposed above a display of a portable electronic device.

21. The portable electronic device of claim 20, wherein the cover sheet forms a smooth exterior surface of the portable electronic device and has a matte appearance.
